(19) United States
(12) Patent Application Publication
(10) Pub. No.: US 2005/0097388 A1
(43) Pub. Date: May 5, 2005

(54) Data distributor

(76) Inventor: Kris Land, Poway, CA (US)

Correspondence Address: HOGAN & HARTSON L.L.P., 500 S. GRAND AVENUE, SUITE 1900, LOS ANGELES, CA, 90071-2611, US

(21) Appl. No.: 10/702,257

(22) Filed: Nov. 5, 2003

(51) Int. Cl. G06F 11/00

(52) U.S. Cl. 714/5

(57) ABSTRACT

A data distribution system that includes a plurality of access ports (APs) connected by one or more crossbar switches. Each crossbar switch has a plurality of serial connections, and is dynamically configurable to form connection joins between serial connections. Each AP has one or more serial connections, a processor, memory, and a bus. A first subset of the APs are host and/or peripheral device APs which further include host and/or peripheral device adapters for connecting to hosts and/or peripheral devices. A second subset of the APs are CPU-only APs that are not connected to a host or peripheral device but perform data processing functions. The data distributor system accomplishes efficient data distribution by eliminating a central CPU that essentially processes every byte-of data passing through the system. The data distributor system can be implemented in a storage system such as a RAID system.

### BACKGROUND OF THE INVENTION

1. Field of the Invention

This invention relates to data distribution, and in particular, to data distribution in a data storage system or other distributed data handling systems.

2. Description of the Related Art

In peer-to-peer and mass storage development, data throughput has been a limiting factor, especially in applications such as movie downloads, pre and post film editing, virtualization of streaming media and other applications where large amounts of data must be moved on and off storage systems. One cause of this limitation is that in current systems, every byte of data passing through is handled by a central CPU, internal system buses and the associated main memory. In the following description, a RAID (Redundant Array of Inexpensive Disks) is used as an example of a data storage system, but the analysis is applicable to other systems. A general description of RAID and a description of specific species of RAID, referred to as RAIDn here, may be found in U.S. Pat. No. 6,557,123, issued Apr. 29, 2003 and assigned to the assignee of the present application.

FIG. 5 is an exemplary configuration for a conventional hardware RAID system. One or more hosts 502 and one or more disks 504 are connected to an EPCI bus or buses 508 (or other suitable bus or buses) via host bus adapters (HBAs) 506. The hosts may be CPUs or other computer systems. The EPCI bus 508 is connected to a EPCI bridge 510 (or other suitable bridge). A CPU 514 and a RAM 516 are connected via a front side bus 512 to the EPCI bridge 510. In a RAID system, the CPU 514 and the RAM 516 are typically local to the RAID hardware. In a RAID write operation, data flows from a host 502 to the CPU 514 via the HBA 506, the EPCI bus or buses 508, the EPCI bridge 510, and the front side bus 512; and flows back from the CPU to a disks 504 via the front side bus 512, the EPCI bridge 510, the EPCI bus 508, and the HBA 506. Data flows in the opposite direction in a read operation. All data processing, including RAID encoding and decoding, is handled by the CPU 514.

### SUMMARY OF THE INVENTION

The present invention is directed to a data distribution system and method that substantially obviates one or more of the problems due to limitations and disadvantages of the related art.

An object of the present invention is to provide a data distribution system that is capable of moving large amounts of data among multiple hosts and devices efficiently by using a scheme of destination control and calculation.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention provides a data distribution system, which includes one or more crossbar switches and a plurality of access ports. Each crossbar switch has a plurality of serial connections, and is dynamically configurable to form connection joins between serial connections to direct serial transmissions from one or more incoming serial connections to one or more outgoing serial connections. Each access port has one or more serial connections for connecting to one or more crossbar switches, a processor, memory, and an internal bus. Each of a first subset of the plurality of access ports further includes one or more host adapters and/or peripheral device adapters for connecting to one or more hosts and/or peripheral devices, and each of the first subset of access ports is connected to at least one crossbar switch. Each of a second subset of the plurality of access ports has one or more input serial connections and one or more output serial connections connected to one or more crossbar switches, and is adapted to perform data processing functions.

Optionally, one of the crossbar switches is a control crossbar switch connected to all of the plurality of access ports for transmitting control signals among the plurality of access ports, and one of the plurality of access ports is an allocator CPU access port which is connected to the control crossbar switch via a serial connection, the allocator CPU access port being operable to control the other access ports to direct data transmissions between the other access ports connected via crossbar switches.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic diagram of the basic configuration of a data distribution system according to an embodiment of the present invention.

FIGS. 2(a)-2(f) schematically illustrate the structure of a data distributor according to embodiments of the present invention.

FIG. 3 shows an access port.

FIGS. 4(a) and 4(b) show a data crossbar with connections and join patterns for data write.

FIG. 5 shows a system configuration for a conventional hardware RAID.

### DETAILED DESCRIPTION OF THE PREFERRED EMBODIMENTS

In the following description, a RAID (Redundant Array of Inexpensive Disks) system is used as an example of a data storage system, but the invention may be applied to other systems, such as storage networking, storage pooling, storage virtualization and management, distributed storage, data pathways, data switches and other applications where using multicast and broadcast with this invention art allows for a highly efficient method of moving data.

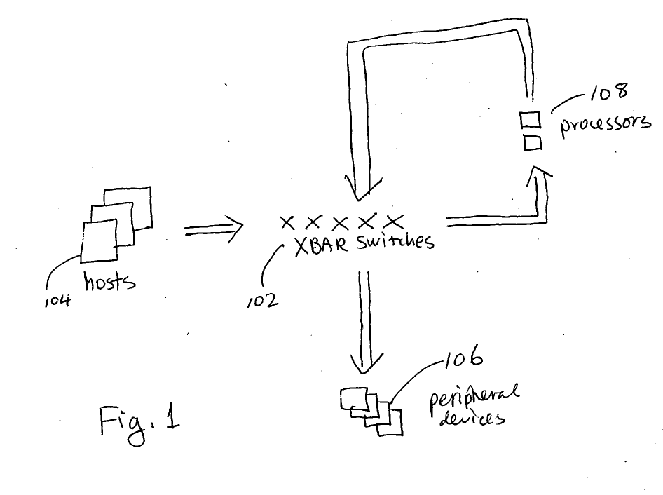

FIG. 1 is a schematic diagram illustrating an overview of the basic configuration of a data distribution system according to an embodiment of the present invention. The basic design of the data distribution system includes four sets of parallel components interconnected to one another. Specifically, the system includes a plurality of crossbar switches (XBAR) 102 which connect a plurality of hosts 104, a plurality of peripheral devices 106, and a plurality of processors 108 together. When two or more crossbars 102 are present, each of the crossbars is preferably connected to each of the hosts 104, to each of the data storage devices 106, and to each of the processors 108. The arrows of the connection lines in FIG. 1 indicate the direction of data movement for a data write operation of a storage device (such as RAID); arrows in opposite directions would apply to a data read operation.

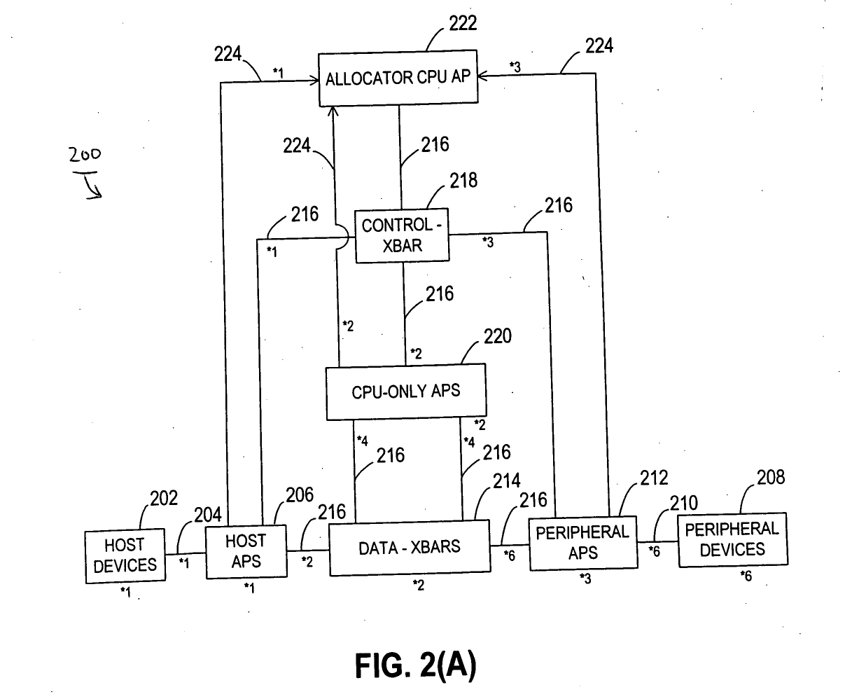

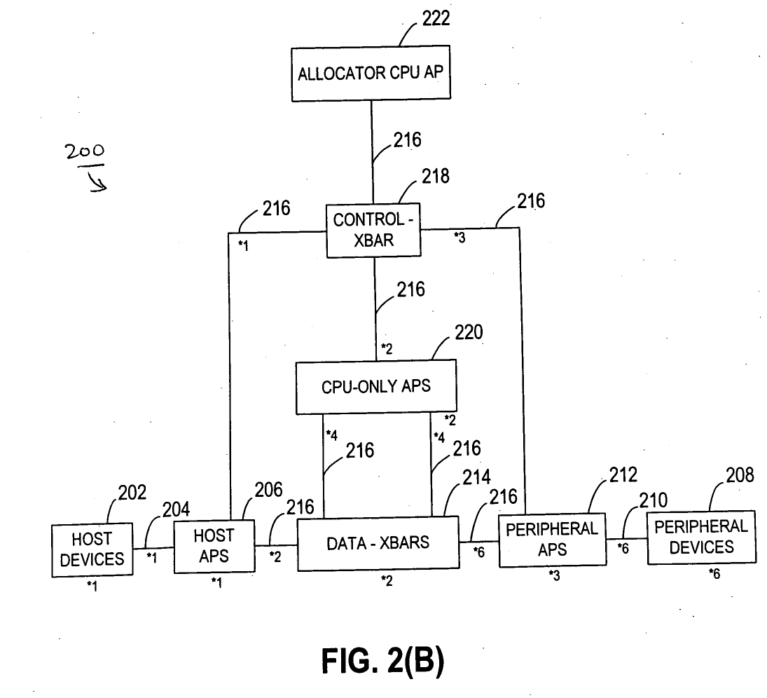

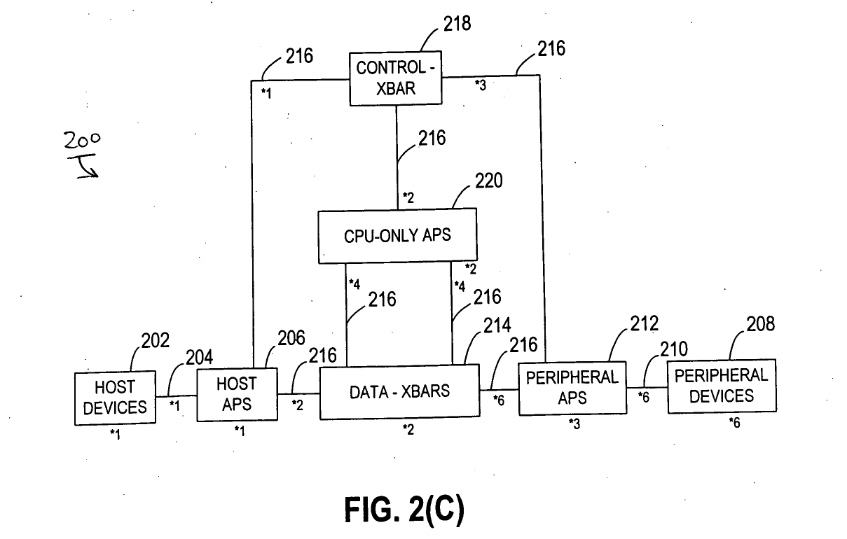

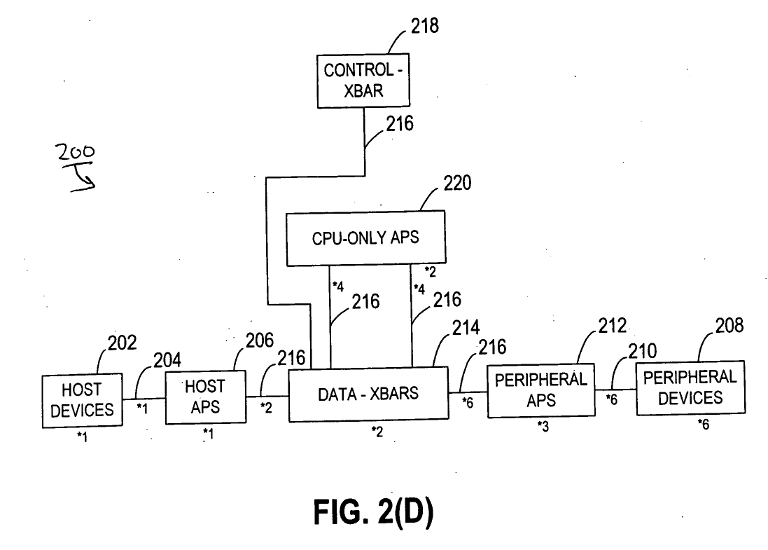

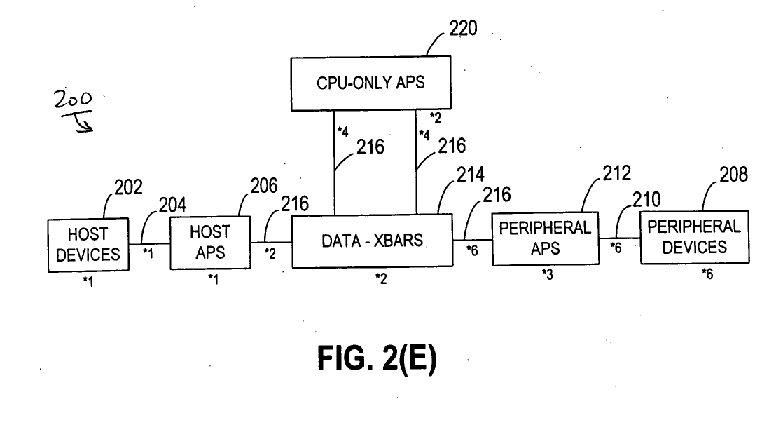

A host 104 is typically a local or remote computer capable of independent action as a master, and may include system threads, higher nested RAID or network components, etc. The plurality of hosts 104 make their demands in parallel and the timing of their demands is an external input to the data distribution system, not controlled by the rest of the system. A queuing mechanism is operated by a processor which may be a specialized one of the processors 108. Such queuing does not involve mass data passing, but only requests passing. A peripheral device 106 is typically a local or remote device capable of receiving or sending data under external control, and may be data storage devices (disks, tapes, network nodes) or any other devices depending on the specific system. The processors 108 may be microprocessors or standard CPUs, or specialized hardware such as wide XOR hardware. They perform required data processing functions for the data distribution system, including RAID encoding and decoding, data encryption and decryption or any related compression and decompression or redundancy algorithms that may relate to mass storage or distributed networks, etc. As described earlier, optionally, one or more processors 108 may be specialized in control functions and control the data flow and the operation of the entire system including other processors. Control of data flow will be described in more detail later with reference to FIGS. 2-4. The arrows in FIG. 1 indicate the basic way data would move for a write operation. Data movement would be different for a read or other operations, as will be describe in more detail with reference to FIGS. 2-4.

By using the crossbars 102 to connect the other components 104, 106 and 108, each peripheral device 106 may serve any math processor 108 and any host 104, and each data math processor 108 may serve any host 104 and any data storage devices 106. In addition, the multiple processors 108 may share among themselves the tasks required by heavy demand from the hosts. Data may flow directly between the peripheral devices 106 and the hosts 104, or through the processors 108, depending on the need of the data distribution scheme.

FIG. 2(a) shows a more specific example of a data distributor according to an embodiment of the present invention. As shown in FIG. 2(a), one or more hosts 202 are connected to one or more host access ports (APs) 206 via host connections 204, which may be a SCSI, Fibre Channel, HIPPI, Ethernet, one or more T1's or greater or other suitable types of connections. One or more peripheral devices (such as storage disks, other storage devices or block devices) 208 are connected to one or more peripheral device APs 212 via standard drive buses 210, such as SCSI buses, Fibre Channel, ATA, SATA, Ethernet, HIPPI, Serial SCSI and any other physical transport layer, or other suitable types of connections. The host APs 206, the peripheral device APs 212, and one or more CPU-only APs 220 are connected to crossbar switches (data XBARs) 214. The APs 206, 212 and 220 may optionally be connected to a crossbar switch (control XBAR) 218, which is also connected to an allocator CPU AP 222. All connections between a crossbar and an AP are fast serial connections 216. The host APs 206, peripheral device APs 212 and CPU-only APs 220 are connected to the allocator CPU AP 222 by interrupt lines 224.

To avoid overcrowding the drawings, only one component of each kind is shown in FIG. 2(a), and the labels “*1”, “*2”, etc. designate the number of the corresponding component present in the system (when not indicated, the number of components is one). In addition, each illustrated connection line (e.g. the host connections 204, the standard drive buses 210, the serial connections 216 and the interrupt lines 224) represents a group of connections, each connecting one device at one end of the line with one, device at the other end of the line. For example, six (*6) peripheral devices 208 are connected to three (*3) peripheral device APs 212 via six (*6) standard drive buses 210. As another example, two (*2) data crossbars 214 are present, and each data crossbar is connected to each of the host APs 206, each of the peripheral device APs 212 and each of the CPU-only APs 220. Accordingly, six (*6) serial connections 216 are present between three (*3) peripheral device APs 212 and two (*2) data crossbars 214. Of course, the numbers of components shown in FIG. 2(a) are merely illustrative, and other numbers of components may be used in a data distributor system. For example, multiple (two) data crossbars 214 are shown in FIG. 2(a), but the data distributor may be implemented with a single crossbar (so long as the total number of required connection joins do not exceed the maximum for a crossbar). The system shown in FIG. 2(a) is a complex example of a data distributor, and not all components shown here are necessarily present in a data distributor, as will become clear later.

In the data distributor of FIG. 2(a), both data and control signals are transmitted through the nodes (the host APs 206, peripheral device APs 212, and CPU-only APs 220). Typically, control signals or commands refer to signals that reprogram the access ports or affect their actions through program branching other than by transmission monitoring, transmission volume counting or transmission error detection. Data typically refers to signals, often clocked in large blocks, that are transmitted and received under the control of the programs in the hosts, peripheral devices, and access ports, without changing those programs or affecting them except through transmission monitoring, transmission volume counting and transmission error detection.

In operation, data flows between nodes as directed by the paths in data crossbars 214. The allocator CPU AP 222, which is the master of the data distributor 200, controls the APs 206, 212 and 220 by transmitting control commands to these APs through the control crossbar 218, and receiving interrupt signals from the APs via the interrupt lines 224. The allocator CPU AP 222, under boot load or program control, transmits commands to other APs, receives interrupt or control signals from other APs as well as from hosts, peripheral devices, or other components (not shown) of the network system such as clocks, and synchronizes and controls the actions of all of these devices. The data crossbar 214 is controlled in-band by any sending AP, which is accomplished by preloading the data stream from the sending AP with crossbar in-path commands. For example, a data stream originating from the Host AP 206 may contain a command header in the data stream being sent to the Data Xbar 214 that instructs the Data Xbar 214 to “multi-cast” the data stream to a plurality of peripheral AP's 212. The Host AP may receive its instructions from the Allocator CPU AP 222. The receiving peripheral AP's 212 may receive instructions from the Allocator CPU AP on what to do with the data received from the data XBAR 214.

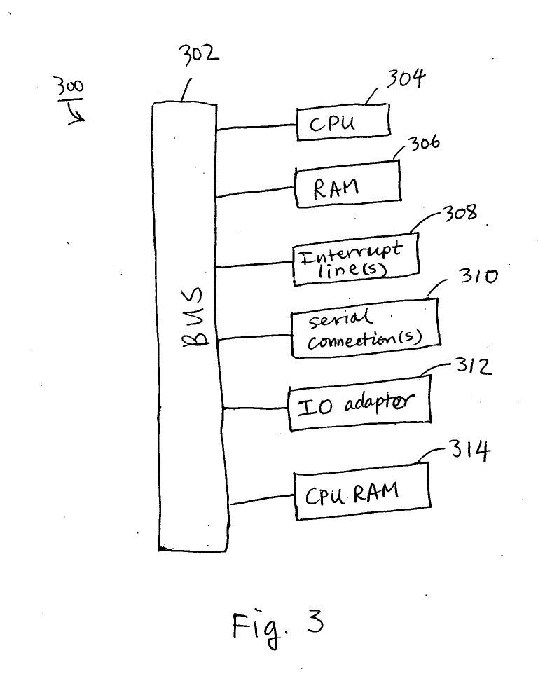

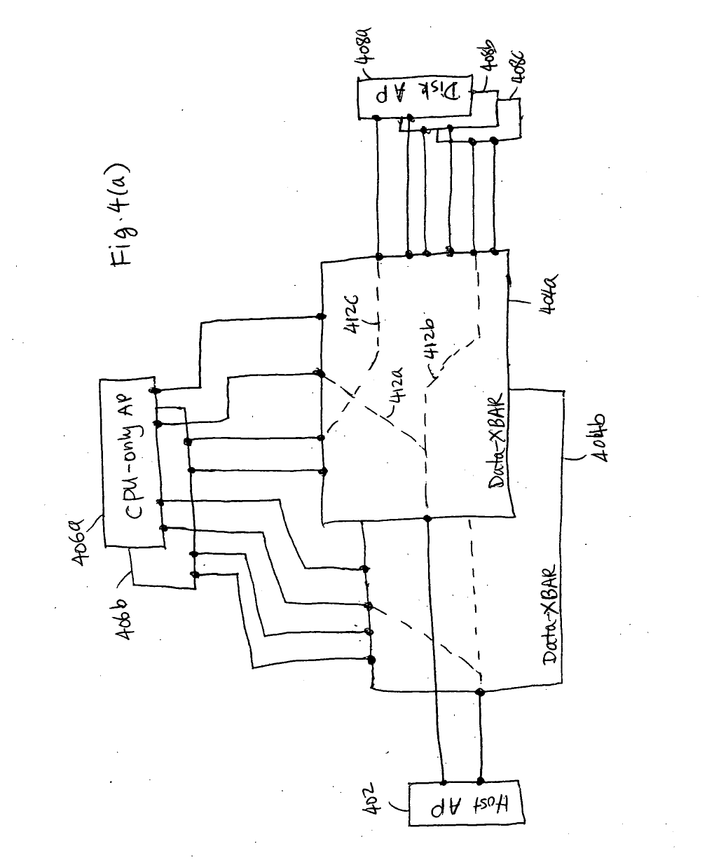

The structure of an access port (AP) is schematically illustrated in FIG. 3. The AP 300 typically include a bus 302, one or more CPU 304, CPU RAM 314 (such as 128 MB of 70 ns DRAM), RAM 306 (such as a 256K to 512 k of fast column RAM), one or more interrupt lines 308, and one or more serial connections 310. The bus 302 may have a typical speed of 533 MB/sec or higher. The serial connections may be fast serial connections matched to the crossbar to which the AP is connected, and capable of communicating data and/or control commands in either direction. The AP 300 optionally contains a ROM (not shown) for an allocator or other coding applications. The AP 300 may also contain an IO adapter 312 capable of connecting to one or more hosts or peripheral devices, via SCSI, ATA, Ethernet, HIPPI, Fibre Channel, or any other useful hardware protocol. The IO adapter provides both physical transmission exchanges and transmission protocol management and translation. Because of the presence of the CPU RAM 314, the AP 300 is capable of running a program, accepting commands via a serial connection 310, sending notification via an interrupt line 308, etc. By using RAM 306, the AP 300 is capable of buffering data over delays caused by task granularity, switch delays, and irregular burdening. Of course, a single RAM or other RAM combination may be used in lieu of the CPU RAM 314 and the RAM 306 shown in FIG. 3 as the processor's internal memory; preferably, such RAM or RAM combination should allow the AP to perform the above described functions at a satisfactory speed. The AP 300, under program control, is capable of creating, altering, combining, deleting or otherwise processing data by programmed computation, in addition to transmitting or receiving data to or from hosts and peripheral devices. The programming on the APs is preferably multitasked to run control code in parallel with data transmissions.

Depending on the presence or absence of the adapter and, if present, the type of the adapter, an APs may be (1) a peripheral device AP (such as devices 212 in FIG. 2(a)) adapted for connection to one or more peripheral devices, (2) a host AP (such as devices 206 in FIG. 2(a)) adapted for connection to one or more hosts, (3) a CPU-only AP (such as device 220 or 222 shown in FIG. 2(a)) lacking an adapter, or other suitable types of APs. For example, the adapter in a peripheral device AP 212 may be a SCSI HBA, and the adapter in a host AP 206 may be an HIPPI adapter. Alternatively, a single adapter suitable for connection to either hosts or peripheral devices may be used, and the AP may thus be a host/peripheral device AP. A host AP and peripheral device AP may be one-sided at any given time from the adapter and data serial line point of view. “One-sided” refers to certain interface types where the interface requires an initiator and a target that behave differently from each other; “one-sided” does not mean that data flows in one direction. However both the host AP and the peripheral device AP is preferably capable of transmission in both directions over their lifetime. Preferably, the programming for a host AP 206 causes it to look like a slave (such as a SCSI “target”) to the host(s) 202 on its adapter, while the programming for a peripheral device AP 212 causes it to look like a master (such as a SCSI “initiator”) to the peripheral device(s) 208 on its adapter. A host/peripheral device AP switches between these two rolls. The slave/master distinction is independent of which direction the data flows.

A CPU-only AP lacks a host or peripheral device adapter, and is typically used for heavy computational tasks such as those imposed by data compression and decompression, encryption and decryption, and RAID encoding and decoding. A CPU-only AP typically requires two serial connections 310, i.e., both input and output serial data connections simultaneously.

A special case of a CPU-only AP is the Allocator CPU AP (device 222 in FIG. 2(a)). Unlike other APs, which each has an output interrupt line, the Allocator CPU AP has several input interrupt lines. Also unlike other APs, it does not require serial data connections for transmitting data; it requires only serial control connections for transmitting control signals. It is typically supplied with a larger CPU RAM 314 to run the master control program, which may be placed on an onboard ROM, or transmitted in through an optional boot load connection.

As is clear from the above description, not all components shown in FIG. 3 are required for an AP. The minimum requirement for an AP is an internal bus 302, a CPU 304, a RAM 306 or 314, and a serial connection 310. As will be described later with reference to FIGS. 2(b)-2(e), the interrupt lines 308 (224 in FIG. 2(a)) may be omitted and their function may be performed by a serial connection 310.

A crossbar switch (XBAR) is a switching device that has N serial connections, and up to N(N−1)/2 possible connection joins each formed between two serial connections. A typical crossbar may have N=32 serial connections. It is understood that “serial connections” here refer to the ports or terminals in the crossbar that are adapted for fast serial connections, which ports or terminals may or may not be actually connected to other system components at any given time. In use, a subset of the N(N−1)/2 possible connection joins may be activated and connected to other system components, so long as the following conditions are satisfied. First, at a minimum, each activated connection join connects one device that transmits data and one device that receives data. Second, no two connection joins share a data receiving device. The access ports connected to the crossbars, under program control, control the crossbar switches by rearranging the serial transmission connections to be point to point (uni-cast), one to many (multi-cast) or one to all (broadcast). Preferably, rearrangement occurs when the previous transmissions through the switch are complete and new transmissions are ready. Thus, the crossbar can be configured dynamically, allowing the crossbar configurations to change whenever necessary as required by the data distribution scheme.

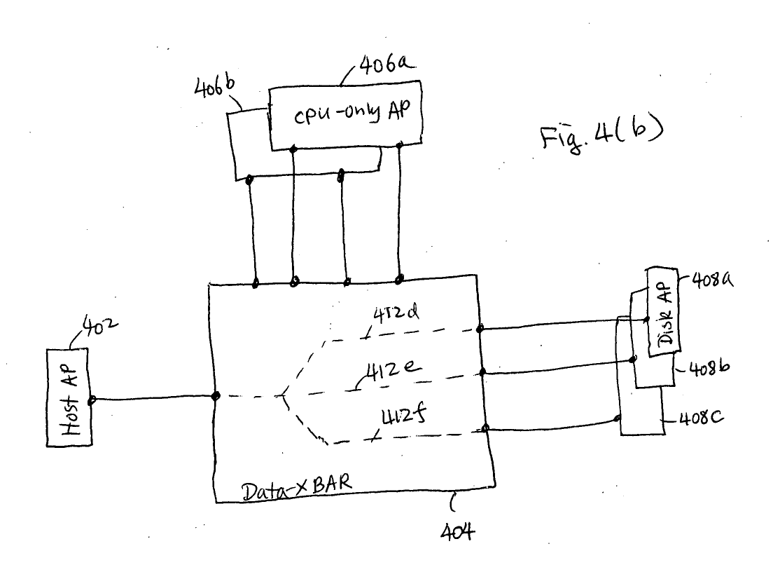

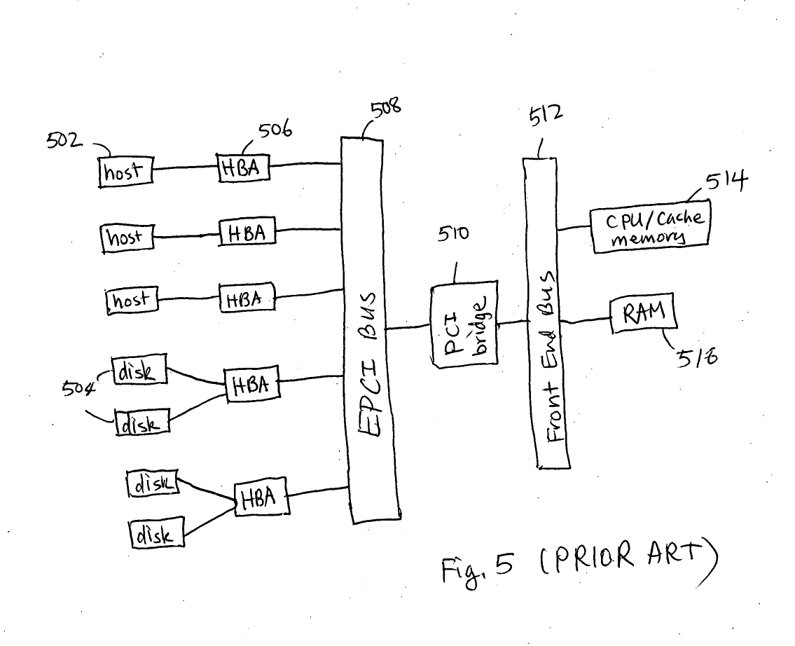

FIGS. 4(a) and 4(b) illustrate two examples of connection join patterns of a data crossbar in normal host (uni-cast or point to point) and rapid host (Multi-cast) setups, respectively, for data write. The configurations for data read may be suitably derived; for example, in the case of FIG. 4(a), data read may be illustrated by reversing the direction of the arrows. FIG. 4(a) is an example for a RAID5 or RAIDn write, at a time when the parity calculation for a previous stripe is completed, and the parity calculation for the next stripe is just starting. In this exemplary system, each of two data crossbars 404a and 404b is connected to a host AP 402, to each of two CPU-only APs 406a and 406b, and to each of three peripheral device APs 408a, 408b and 408c, via fast serial connections. In particular, the connections between each data crossbar and each CPU-only AP include a pair of fast serial connections as shown in the figure, for example, connection 410a from the first data crossbar 404a to the first CUP-only AP 406a, and connection 410b in the reverse direction. The two data crossbars 404a and 404b have identical configurations, and each may receive every second bit, byte, block or unit of the data, for instance, for increased throughput.

The dotted lines 412a, 412b and 412c shown within the data crossbars represents connection joins, i.e. the path of data movement between connections. In this particular example, data moves in a direction from left to right for data write (and reversed for data read, not shown). Specifically, at this stage of a RAID5 or RAIDn write, data is moving from the host AP 402 to the CPU-only AP 406a (via path 412a) to start the new parity calculation for the next stripe, as well as to the peripheral device AP 408c (via path 412b) for storage. The parity data calculated by the CPU-only AP 406b for the previous stripe is moving from that AP to another peripheral device AP 408a for storage. In the illustrated example, two CPU-only APs are employed, but other configurations are also possible.

The crossbar configuration in FIG. 4(b) is am example for a RAID0 write, or a RAID5 or RAIDn write of a non-parity block. This configuration is similar to that of FIG. 4(a), but only one data crossbar 404 is involved in the operation. Data moves from the host 402 to each of the three peripheral device APs 408a, 408b and 408c via paths 412d, 412e and 412f. This configuration is advantageous in a situation where the host AP 402 has approximately the same connection speed as the total throughput of all connected peripheral device APs. Using this configuration, each data packet from the host AP is broadcast to all peripheral device APs, and data received may be selectively used or thrown away by the peripheral devices, without sacrificing system speed.

In general, the APs, under program control, are capable to accumulate data in their RAMs and buffer the data as appropriate for the efficient interleaving and superimposing of transmissions through crossbar switches.

One specific application of the data distributors according to embodiments of the present invention is a RAID data storage system, where a plurality of disks are connected to the data crossbar via disk APs. Various RAID configurations include RAID0, RAID 1, RAID10 (also referred to as combined RAID), RAID5, RAIDn (which is ideally tuned for this invention), etc. In a RAID0 configuration, each bit, byte or block of data is written once in one of the disks. In a RAID0 write operation in the conventional system (FIG. 5), the data goes from one host 502 sequentially to all of the disks 504. Each disk 504 receives a number of blocks (including one block) and then the next disk becomes active. In the conventional system (FIG. 5), the EPCI bus 508 is traversed seven times assuming a write to all of six Disks 504. Thus, assuming a bus speed of 266 MB/Sec, the maximum transfer rate would be 38 MB/Sec (266 MB/Sec dividing by seven). Using the data distributor according to an embodiment of the present invention (FIG. 2(a)), data can be broadcast from the host APs to the disk APs simultaneously, which the disk APs selectively use or throws away the received data. Using the data distributor according to another embodiment (FIG. 4(b)), when the Host 402 and Disk 408 busses are identical in speed to the conventional system example above (ULTRA SCSI 320), by using the data distributor design, the maximum transfer rate will be 320 MB/Sec., i.e., limited by the Host bus speed only. Further, by using a subtractive logic approach, the Disk AP's would simply ignore or delete the received data that would not be sent to their respective Disks.

In a RAID10 configuration (using a six-disk RAID as an example), a RAID0 of three disks is mirrored by an identical RAID0 of three disks. The read of a RAID10 is equivalent to a RAID0 by alternating mirror selection stripe by stripe in the standard way. For RAID10 writes, two writes (to two disks) are performed for every read (from a host). In the conventional system (FIG. 5), each of the two HBA gets its copy from the RAM 516. In the data distributor (FIG. 2), data flows once from the host 202 via the host AP 206 to the data crossbar 214, and two copies are sent by the crossbar to two disks 210 via two disk APs 212.

In a RAID5 storage system, parts of the data written to the disks are data provided by the user (user data) and parts of the data are redundancy data (parity) calculated from the user data. For example, a six-disk array may be configured so that six blocks of data are written for every five blocks of user data, with one block being parity. Data read for RAID5 is similar to the RAID0 and the RAID10 read in efficiency. Data write for RAID5 involves the steps of fetching five blocks of user data and calculating one block of parity, and storing the parity block, as follows:

| | |
|---|---|
| a>fetch | Block0 |
| b>fetch/XOR | Block1 |
| c>fetch/XOR | Block2 |
| d>fetch/XOR | Block3 |
| e>fetch/XOR | Block4 |
| f>store | Block5 |

In the conventional system (FIG. 5), for every five blocks of user data, five blocks of data would move from the host 502 to the RAM 516, five from the RAM to the CPU 514 through the front end bus 512 in the fetching steps, one from the CPU to the RAM through the front end bus in the storing step, and six from the RAM to the disk 504. In the data distributor according to an embodiment of the present invention (FIG. 2(a)), the data crossbar 214 may be used to distribute data efficiently. For example, in the five fetching steps, the user data blocks may be directed simultaneously through the data crossbar to two destinations, the disk APs 212 and the CPU-only APs 220 (fetch). In addition, the block of parity data from the previous calculation may be directed to its parity disk for store at the same time the current first fetching step a> is being performed, by an independent transmission through the data crossbar. It can be seen that the data distributor according to embodiment of the present invention increases the efficiency of data distribution in the RAID systems.

Referring back to FIG. 2(a), in the data distributor system shown therein, data flow of the entire system is controlled by the Allocator CPU AP 222. The Allocator AP 222 communicates with the nodes (the host APs 206, the peripheral device APs 212 and the CPU-only APs 220) via serial connections 216 (through the control XBAR 218) and the interrupt lines 224. In addition, by setup transmissions to the nodes, the Allocator CPU AP 222 notifies the nodes to perform particular actions according to the desired data distribution scheme. The command transmissions and setup transmissions are typically small, infrequent and quick. The nodes then controls the XBARs by transmitting commands to the XBAR in-band. The data processing is primarily handles by the CPU-only APs 220; the Allocator CPU AP 222 merely directs large amounts of data to individual math processors after notifying them of their task, but does not actually process each byte of data. Thus, this data distribution system reduces the amount of data processing performed by any central processor, and increases the speed and efficiency of data distribution. For example, if data transmission is handled in packets of at least 512 bytes, and control by the CPU is managed by a single 4-byte word, an improvement of more than 100-fold may be achieved over a conventional system in which data processing (e.g. encoding and decoding) is performed by a central CPU.

FIGS. 2(b)-2(e) illustrate alternative structures of a data distributor according to other embodiments of the present invention. Like components in FIGS. 2(b)-2(e) are designated by like or identical reference symbols as in FIG. 2(a). In the structure of FIG. 2(b), the interrupt lines are eliminated, and the Allocator CPU AP 222 communicates with the nodes 206, 212 and 220 in both directions via serial connections 216 and the control XBAR 218.

In the structure of FIG. 2(b), the Allocator CPU AP 222 may be eliminated and its functions performed by one of the CPU-only APs 220, and/or the control XBAR 218 may be eliminated and its functions performed by one of the data XBARs 214. FIG. 2(c) illustrates a structure where the Allocator CPU AP 222 is eliminated and its functions performed by one of the CPU-only APs 220. This CPU-only AP 220 is connected to the host APs 206 and the peripheral device APs 212 via serial connections 216 and the control XBAR 218. FIG. 2(d) illustrates a structure where the control XBAR 218 is eliminated and its functions performed by one of the data XBARs 214. The Allocator CPU AP 222 is connected to this data XBAR 214 via a serial connection 216 and communicates with the nodes 206, 212 and 220 via this data XBAR 214. This is referred to as in-path communication. FIG. 2(e) illustrate a structure where the Allocator CPU AP 222 is eliminated and its functions performed by one of the CPU-only APs 220, and the control XBAR 218 is eliminated and its functions performed by one of the data XBARs 214. Comparing FIG. 2(e) with the overview illustration of FIG. 1, it may be seen that components 202 and 206 correspond to component 104, components 212 and 208 correspond to component 106, component 220 corresponds to component 108, and component 214 correspond to component 102.

In the structures of FIGS. 2(b)-2(e), the APs have structures similar to that shown in FIG. 3 but without the interrupt line(s) 308. Other aspects of the alternative structures of FIGS. 2(b)-2(e) are identical or similar to those described above for the structure of FIG. 2(a).

It will be apparent to those skilled in the art that various modifications and variations can be made in a data distribution system and method of the present invention without departing from the spirit or scope of the invention. Thus, it is intended that the present invention cover modifications and variations that come within the scope of the appended claims and their equivalents.

1. A data distribution system for distributing data among components of a data processing system including hosts and peripheral devices, the system comprising:
one or more crossbar switches each having a plurality of serial connections, each crossbar switch being dynamically configurable to form connection joins between serial connections to direct serial transmissions from one or more incoming serial connections to one or more outgoing serial connections; and
a plurality of access ports each having one or more serial connections for connecting to one or more crossbar switches, a processor, a memory, and an internal bus,
wherein each of a first subset of the plurality of access ports further includes one or more host adapters and/or peripheral device adapters for connecting to one or more hosts and/or peripheral devices, and each is connected to at least one crossbar switch, and
wherein each of a second subset of the plurality of access ports includes one or more input serial connections and one or more output serial connections connected to one or more crossbar switches, and is adapted to perform data processing functions.

2. The data distribution system of claim 1, wherein at least one of the plurality of access ports is an allocator CPU access port which is connected to at least one crossbar switch via a serial connection, the allocator CPU access port being operable to control the other access ports to direct data transmissions between the other access ports connected via the crossbar switches.

3. The data distribution system of claim 3, further comprising interrupt lines connected between the allocator CPU access port and the other access ports.

4. The data distribution system of claim 1, wherein one of the crossbar switches is a control crossbar switch connected to all of the plurality of access ports for transmitting control signals among the plurality of access ports.

5. The data distribution system of claim 1, wherein the crossbar switches are dynamically configured in-band by one or more access ports connected thereto.

6. The data distribution system of claim 1, wherein each of the first subset of access ports is operable to transmit or receive data to or from hosts or peripheral devices .

7. The data distribution system of claim 1, wherein at least some of the access ports are operable to buffer data within the access ports and to transmit buffered data in an interleaving or superimposing manner through crossbar switches.

8. The data distribution system of claim 1, wherein a crossbar switch is configured to simultaneously direct an incoming serial transmission from one sending access port to a plurality of receiving access ports, each receiving access port either discards the transmission, or utilizes the transmission for further processing or transmission.

9. The data distribution system of claim 1, wherein the second subset of access ports operate to perform parallel computations and are connected with a plurality of crossbar switches.

10. The data distribution system of claim 1, wherein the second subset of access ports operate individually or in parallel to compute RAID and/or RAIDn parity encoding and decoding.

11. The data distribution system of claim 1, wherein the second subset of access ports operate individually or in parallel to compute data encryption and decryption.

12. The data distribution system of claim 1, wherein any of the first subset of access ports operate in a uni-cast mode, a multicast mode, and/or a broadcast mode.

13. The data distribution system of claim 1, wherein the host adapters and/or peripheral device adapters provides both physical transmission exchange and transmission protocol management and translation.

14. A data distribution system for distributing data among components of a data processing system including hosts and peripheral devices, the system comprising:
one or more crossbar switches each having a plurality of serial connections, each crossbar switch being dynamically configurable to form connection joins between serial connections to direct serial transmissions from one or more incoming serial connections to one or more outgoing serial connections; and
a plurality of access ports each having one or more serial connections for connecting to one or more crossbar switches, a processor, a memory, and an internal bus,
wherein each of a first subset of the plurality of access ports further includes one or more host adapters and/or peripheral device adapters for connecting to one or more hosts and/or peripheral devices, and each is connected to at least one crossbar switch,
wherein each of a second subset of the plurality of access ports includes one or more input serial connections and one or more output serial connections connected to one or more crossbar switches, and is adapted to perform data processing functions,
wherein one of the crossbar switches is a control crossbar switch connected to all of the plurality of access ports for transmitting control signals among the plurality of access ports, and
wherein at least one of the plurality of access ports is an allocator CPU access port which is connected to the control crossbar switch via a serial connection, the allocator CPU access port being operable to control the other access ports to direct data transmissions between the other access ports connected via crossbar switches.

15. The data distributor system of claim 14, further comprising interrupt lines connected between the allocator CPU access port and the other access ports.
